(19) United States
(12) Patent Application Publication
(10) Pub. No.: US 2006/0203381 A1
(43) Pub. Date: Sep. 14, 2006

(54) Magnetic recording head for perpendicular recording, fabrication process, and magnetic disk storage apparatus mounting magnetic head

(75) Inventors: Tomohiro Okada, Kanagawa (JP); Kimitoshi Etoh, Kanagawa (JP); Hisashi Kimura, Kanagawa (JP); Isao Nunokawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/372,833

(22) Filed: Mar. 10, 2006

(30) Foreign Application Priority Data
Mar. 11, 2005 (JP) 2005-069143

(51) Int. Cl. G11B 5/127

(52) U.S. Cl. 360/125

(57) ABSTRACT

A magnetic head for perpendicular recording in which a reduction of an interval between a main pole and a read element is attained by suppressing the phenomenon due to a magnetic field from the main pole entering a read shield and thereby output of the read head being varied. In one embodiment, the shield nearer the main pole of the read head is formed in the three-layer structure of the magnetic layer/non-magnetic layer/magnetic layer.

### CROSS-REFERENCES TO RELATED APPLICATIONS

This application claims priority from Japanese Patent Application No. JP2005-069143, filed Mar. 11, 2005, the entire disclosure of which is incorporated herein by reference.

### BACKGROUND OF THE INVENTION

The present invention relates to a magnetic head used for recording and reading magnetic recording media, also to a method of manufacturing the same magnetic head and to a hard disk drive mounting the same magnetic head.

A hard disk drive reads and writes data from and to the recording disks using magnetic heads. In view of increasing the recording capacity per unit area of a magnetic disk, it is essential to improve an a real recording density to higher density. However, the present longitudinal recording system has a problem that the a real recording density cannot be raised due to thermal fluctuation in the magnetization of a medium, if the recording bit length becomes small. As a method for solving this problem, the perpendicular recording system has been proposed, in which the magnetization signal is recorded in the perpendicular direction to the surface of a medium. In this perpendicular recording system, a giant magneto-resistive head can be used to read the data. Moreover, a tunneling magneto-resistive head which can provide larger read output and a CPP (Current-Perpendicular-to-Plane) type GMR head which causes the current to flow perpendicularly to the film surface can also be used.

Meanwhile, a single pole head must be used for recording of data. Even in the perpendicular recording, both track density and linear recording density must be increased in order to improve the a real recording density. For increasing the linear recording density, the gradient of recording magnetic field of the recording head must be increased. As a method of this purpose, it has been proposed to form a structure in which the double-layer is employed for a recording medium and a soft-magnetic layer is provided as the lower layer. However, in order to achieve the higher recording density exceeding 200 Gb/in², increase in the magnetic field gradient from the recording head and control of spread in writing of data or the like are also required. For the increase in the magnetic field gradient, it has been proposed, for example, to introduce a structure that a trailing shield is provided at the area near the main pole. For the control of spread in the writing of data, US2002/0176214A1 discloses an example of the magnetic head for perpendicular recording in which a side shield is provided. Moreover, JP-A No. 127480/2004 discloses an example of the magnetic head for perpendicular recording in which the side shield is also provided. In addition, JP-A Nos. 34916/2001 and 182226/2000 disclose an example of the structures in which the double-layer is employed for the read shield. Moreover, JP-A No. 20916/2000 describes a magnetic head in which a lower magnetic core which is also used in common as an upper shield film of the read shield is formed of two layers of magnetic layer via a non-magnetic layer.

### BRIEF SUMMARY OF THE INVENTION

In the case of providing a trailing shield or a side shield to a recording head, it is preferable to provide a main pole 12 to the side nearer to a read head for improvement in format efficiency of a hard disk drive and convenience in connection between the trailing shield, side shield and a return pole 11. However, the study by the inventors has revealed that the magnetic field from the main pole 12 or a yoke 14 enters the upper read shield 17 of the read head and varies an output of the read head as indicated by an arrow mark 31 (see FIG. 1). This problem may be solved by expanding the distance between the main pole and the read head. However, in this case, the format efficiency of the hard disk drive cannot be improved because the distance between a read element of the read head and the main pole is expanded.

US2002/0176214A1 and JP-A No. 127480/2004 do not explain influence of the magnetic field entering the read head from the recording head. Moreover, JP-A Nos. 34916/2001 and 182226/2000 relate to a magnetic head for longitudinal recording. JP-A No. 34916/2001 discloses a structure in which the double-layer is introduced for the shield of read head. However, in this case, a non-magnetic layer to control instability of the shield itself is not inserted between two layers. JP-A No. 182226/2000 shows an example wherein a highly thermal conductive material is used to radiate the heat generated from the magnetic head. JP-A No. 20916/2000 shows an example wherein generation of noise is controlled through difference of characteristics of two laminated layers of magnetic layer of the shield which is also used in common as a part of the recording head.

Considering the problems described above, a feature of the present invention is to provide a magnetic head for perpendicular recording which is freed from the influence on the read head of the magnetic field from the recording head and is also to provide a hard disk drive which has enhanced the format efficiency by mounting the magnetic head for perpendicular recording.

The present invention relates to a magnetic head for perpendicular recording having a main pole and a return pole to a read head, and a recording head utilizing the magnetoresistive effect, which is characterized in that the main pole is provided between the return pole and the read head, and a read shield provided nearer to the main pole of the read head is formed of three or more layers including a lower shield layer, a non-magnetic layer, and an upper shield layer. The layers of three or more layers of the read shield 3 may also be formed of the plating process.

According to the present invention, the magnetic head for perpendicular recording which has suppressed variation in the read output of the read head due to the magnetic field from the main pole can be obtained and the hard disk drive having improved the format efficiency can also be obtained by reducing the distance between the main pole of the magnetic head for perpendicular recording and the read element.

### BRIEF DESCRIPTION OF THE DRAWINGS

FIG. 1 is a schematic diagram of the trailing side shield type magnetic head for perpendicular recording.

FIG. 2 shows: (a) a diagram showing variation in output of the read head of the conventional trailing shield type magnetic head for perpendicular recording, and (b) a diagram showing variation in output of the read head of the conventional magnetic head for perpendicular recording in which the return pole is near the read head.

FIG. 3 is a schematic diagram of the hard disk drive.

FIG. 4 is an explanatory diagram of the perpendicular recording system.

FIG. 5 is a cross-sectional view showing an example of the magnetic head for perpendicular recording according to an embodiment of the present invention.

FIG. 6 is a diagram showing variation in output of the read head of the magnetic head for perpendicular recording of the present invention.

FIGS. 7a-7g are diagrams showing manufacturing processes of the magnetic head for perpendicular recording according to an embodiment of the present invention.

FIG. 8 is a diagram showing relationship between the slider (magnetic head for perpendicular recording) and the floated disk.

FIG. 9(a) is a diagram showing the conventional magnetic head for perpendicular recording.

FIG. 9(b) is a diagram showing the magnetic head for perpendicular recording according to an embodiment of the present invention.

FIG. 9(c) is a diagram showing the magnetic head for perpendicular recording according to another embodiment of the present invention.

FIGS. 10a-10b are diagrams for comparing the conventional magnetic head for perpendicular recording with the magnetic head for perpendicular recording of the present invention when the coil is formed in double-layer.

### DETAILED DESCRIPTION OF THE INVENTION

In the case of a magnetic head for perpendicular recording in which a main pole is provided between a read head and a return pole, it has been revealed that the magnetic field formed by the main pole enters the read head to shift a magnetic domain in a read shield resulting in influence on a read element formed, for example, of a giant magnetoresistance film and thereby a read output is varied.

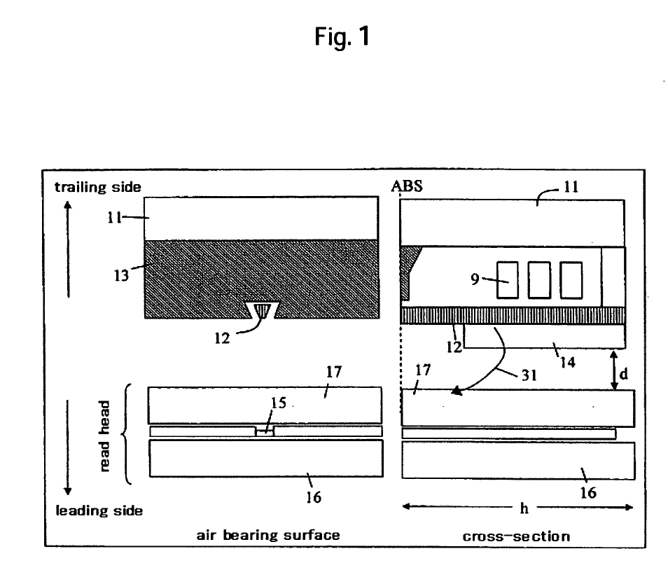

The inventors have manufactured in trial a magnetic head for perpendicular recording which is schematically illustrated in FIG. 1 and studied the recording and reading characteristics thereof. This magnetic head for perpendicular recording is provided with a recording head and a read head. The recording head includes a main pole 12, a yoke 14, a return pole 11, a coil 9, and a trailing shield 13, while the read head has a structure that a read element 15 is sandwiched by a lower read shield 16 and an upper read shield 17. In the recording head, the main pole 12 is located nearer to the read head than the return pole 1 1. The yoke 14 may be provided or may not be provided. The film thickness of the main pole 12 on a wafer ranges from about 0.1 to 0.2 μm, while the film thickness of yoke ranges from about 0.2 to 1 μm. As a material of the main pole 12, the material having a high saturation magnetic flux density (Bs) is recommended and Fe(70 at %)Co or the like, for example, is used. As a material of the yoke 14, a permalloy or the like of Ni(80 at %)Fe is used and a composition of negative magnetic strain is used in such a sense as controlling the magnetic domain thereof. The throat height of the main pole 12 (distance up to the flare point from the air bearing surface) is about 0.1 to 0.2 μm and the end part of the yoke 14 is located at the position further separated from the air bearing surface (typically, 0.5 to 2 μm).

The inventors also manufactured in trial the two kinds of magnetic head for perpendicular recording having the interval d between the upper surface of the read head and the lower surface of the yoke 14 of 4 μm and 8 μm. Recording has been conducted in various recording frequencies to a double-layer perpendicular medium including a soft-magnetic underlayer using this magnetic head for perpendicular recording and thereafter changing rates of output from the read header have been measured. Here, the changing rate of output of the read head is expressed by measuring a read output, when the recording and reading operations have been conducted for 10,000 times in a certain recording frequency using a spin-stand apparatus and by dividing a difference between the maximum value and the minimum value of such read output with an average value thereof.

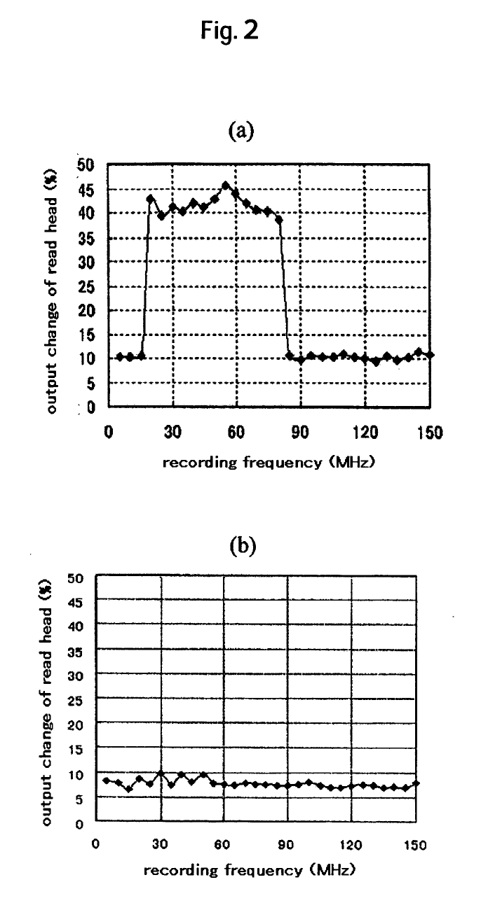

Results of measurements are illustrated in FIG. 2. The horizontal axis of FIG. 2 represents the recording frequency, while the vertical axis represents the output changing rate of the read head. Changes of output as illustrated in FIG. 2(a) have been observed in any of the two kinds of magnetic heads for perpendicular recording manufactured in trial. Moreover, the inventors also have thought that influence of magnetic field from the main pole is rather small when the length from the air bearing surface of the shield is short. On the basis of this concept, the inventors have also manufactured in trial three kinds of the magnetic heads for perpendicular recording in which the distance between the upper surface of the read head and the lower surface of the yoke 14 is 8 μm and the length h from the air bearing surface of the shield has been varied as 50 μm, 16 μm, and 6 μm, and have investigated the results of these magnetic heads. As a result, variations in read output which are similar to that of FIG. 2(a) have been observed. On the other hand, the inventors have also conducted similar measurements using the conventional magnetic head for perpendicular recording in which the return pole is located at the area nearer to the read head. The result has not revealed the phenomenon as illustrated in FIG. 2(b) that output changing rate of the read head becomes larger in a particular recording frequency.

In the magnetic head for perpendicular recording as illustrated in FIG. 1 in which the main pole 12 of the recording head is located at the position nearer to the read head than the return pole 11, it can be thought that changes of output are generated within the range of the particular recording frequencies based on the mechanism described below. Namely, read output is thought to change because the magnetic field from the main pole enters the read shield which is nearer to the main pole, this magnetic field resonates at a certain frequency with the magnetic domain existing in this read shield, whereby the magnetic domain shifts and the magnetic field induced by the shifted magnetic domain drives magnetization of a read element.

In view of suppressing variations in output of this read head, the present invention employs a structure where a non-magnetic layer is allocated between magnetic layers by forming the read shield located nearer to the main pole is formed in the structure of three or more layers. According to this structure, when the magnetic field generated by the main pole enters the read shield, the magnetic domain of the shield nearer to the read element is never disturbed and thereby variation in output of the read element can be suppressed because even if the magnetic domain of the shield nearer to the main pole is disturbed, a non-magnetic layer is provided under such shield. Employment of this structure enables that the distance between the main pole and read element is shortened, format efficiency of a hard disk drive is improved, and storage capacity of the drive is increased.

The shield of three or more layers in the read head can be formed with a method in which a resist frame is formed after formation of a seed layer for plating and a magnetic layer, a non-magnetic layer, and a magnetic layer are plated using this resist frame. Moreover, as the other applicable method, it is possible that a magnetic layer, a non-magnetic layer, and a magnetic layer are formed to the entire surface of the wafer with the plating method or sputtering method, and a pattern is formed with the etching process using a resist pattern as the mask. As the magnetic layer, NiFe, FeNi, and FeNiCo may be applicable. As the magnetic layer nearer to the main pole of the read shield of three or more layers, FeNi or FeNiCo may be applicable as the materials having a smaller linear expansion coefficient. In the case of the FeNi material, desirable composition of Ni is about 30 to 50 at %. In the case of the FeNiCo material, the desirable composition of Ni is about 30 to 50 at % and the desirable composition of Co is about 3 to 10 at %.

In addition, as the non-magnetic layer, Cu, Au, Ru, Rh, Pd, Ta, NiP, NiPd, and NiP are applicable as the material allowing the plating process. Moreover, an oxide film of Al₂O₃, SiO₂, Ta₂O₅, TiO₂ or the like formed by the sputtering method or a non-magnetic metal of Cr, Ta, W, Cu, Au, Ru, Rh, Pd, Ta, NiP, NiPd and NiP or the like are also applicable. Adequate film thickness of the non-magnetic layer is about 20 nm to 200 nm, because it is desirable for the non-magnetic layer to have the thickness as decoupling the magnetic layers adjacent to upper and lower sides of the non-magnetic layer, namely as not giving influence on the magnetic layer in the side nearer to the read element in the case where the magnetic field enters the magnetic layer nearer to the main pole.

In regard to the film thickness of magnetic layer, the desirable thickness for both magnetic layers nearer to the read element and nearer the main pole is about 0.2 to 1 μm. It is because the film thickness almost equal to that having the magnetic characteristic as the magnetic shield is required and it is also required to consider the distance between the main pole and the read element by lowering the film thickness not to deteriorate the thermal protrusion (TPR) characteristic which is the phenomenon that the element is protruded due to the heat.

The magnetic head for perpendicular recording of the present invention is capable of improving the format efficiency of a magnetic recording apparatus and increasing storage capacity of each apparatus because the distance between the main pole and read element can be made shorter than that of the existing magnetic head for perpendicular recording. Moreover, the magnetic head for perpendicular recording of the present invention is characterized in that the distance between the main pole and read element does not change even when a coil is laminated in two or more layers. The reason of this characteristic is that the coil is manufactured after formation of the read head and main pole. Accordingly, the magnetic recording apparatus having improved the recording performance can be manufactured without deterioration of the format efficiency even if the coil is laminated in two or more layers in view of improving the recording performance.

Moreover, in the case of the head structure of the present invention, thermal protrusion results in a problem because the return pole is located at the lowest point when a slider floats to the trailing side, namely to the location near to the flowing end part. In order to avoid this problem, it is desirable to use FeNi or FeNiCo in the adequate composition of Fe, Ni, and Co for the return pole. When the FeNi material is used, the desirable composition of Ni is about 30 to 50 at %. When the FeNiCo material is used, the desirable composition of Co is about 3 to 10 at %, while the desirable composition of Ni is about 30 to 50 at %.

The present invention will be explained more practically with reference to the accompanying drawings.

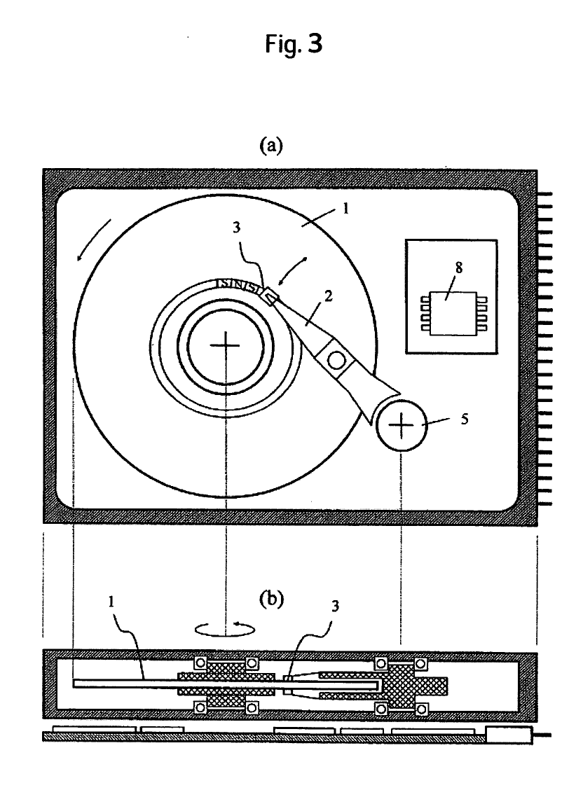

FIG. 3 illustrates the concept of a hard disk drive. FIG. 3(a) is a plan view and FIG. 3(b) is a cross-sectional view. The hard disk drive conducts recording and reading operations of the magnetization signal to a magnetic disk 1 which is driven to rotate with a motor using magnetic heads 3 fixed at the end part of an arm 2. The arm 2 is driven in the disk radius direction with an actuator 5 and is positioned on a track for recording or reading the signal. The recording signal for driving the magnetic head 3 or the reading signal transmitted from the magnetic head are processed with a signal processing circuit 8.

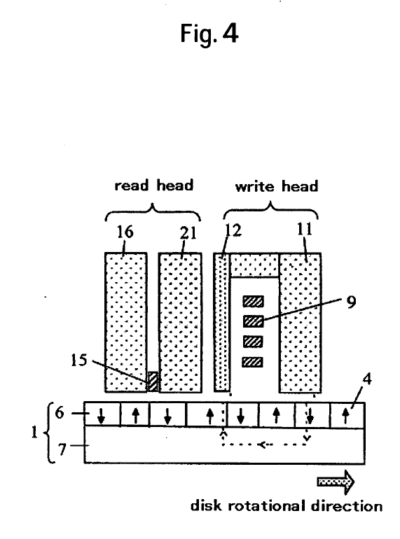

FIG. 4 is a schematic diagram illustrating the perpendicular recording. A magnetic head for perpendicular recording is composed of a recording head and a reading head. The recording head generates a magnetic field for recording to a recording layer of a magnetic disk 1. This head is designed as a single pole head provided with a main pole 12, a return pole 11, and a thin film coil 9 interlinking to a magnetic circuit formed by the main pole and return pole. The reading head is used to read the information written to a magnetic recording layer of the magnetic disk 1 and is also provided with a read element 15 formed of a magneto-resistive sensor such as a GMR element or the like sandwiched by a pair of read shields 16, 21. The magnetic field outputted from the main pole 12 of the recording head forms a magnetic circuit which passes through a magnetic recording layer 6 and a soft-magnetic backing layer 7 of the magnetic disk 1 and enters the return pole 11 and records a magnetization pattern 4 to the magnetic recording layer. In this timing, the shape of the part where the main pole 12 leaves finally a certain point of the magnetic disk, namely the shape of the upper surface (trailing side) and side surface of the main pole applies large influence on the shape of the magnetization pattern because of the relationship with the disk rotating direction.

Moreover, the distance between the main pole 12 and the read element 15 of read head also applies influence on the format efficiency of hard disk drive. When the distance between the main pole 12 and the read element 15 of read head is large, the format efficiency becomes small. As a result, the storage capacity of hard disk drive becomes smaller. Accordingly, an interval between the main pole and the read head should be reduced.

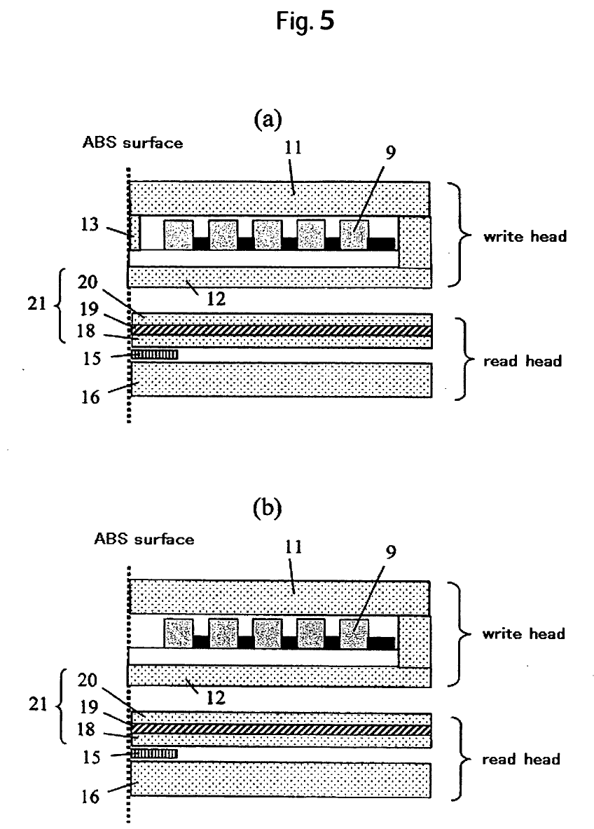

FIG. 5 is a cross-sectional view illustrating an embodiment of the magnetic head for perpendicular recording of the present invention. In the embodiment of FIG. 5(a), a trailing shield or trailing side shield 13 is allocated in the trailing side of the main pole 12. FIG. 5(b) illustrates an embodiment where the trailing shield or trailing side shield is not provided.

A read shield 21 (upper shield) near to the main pole is formed of three layers of a lower shield layer 18 consisting of a magnetic material, a non-magnetic layer 19, and an upper shield layer 20 consisting of a magnetic material.

When the upper read shield is formed of such three-layer structure, only the upper shield layer 20 nearest to the main pole 12 is influenced but the lower shield layer 18 via the non-magnetic layer 19 is never influenced even when the magnetic field from the main pole 12 enters the upper read shield 21 and thereby variation in output of the read head is never generated.

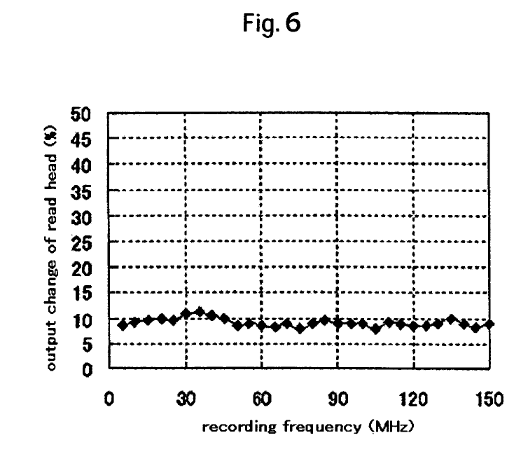

FIG. 6 shows results of measurements of output changing rates with changes in the recording frequency of the read head of the magnetic head for perpendicular recording of the present invention. This graph shows the results of measurements of the head having the structure illustrated in FIG. 5(a). In the case of this head, the Permalloy (0.5 μm thick) of Ni₈₀Fe₂₀ is used for the lower shield layer 18, while the NiP film (0.1 μm thick) for the non-magnetic layer 19 and the invar alloy of Ni₃₅Fe₆₅ (0.5 μm thick) for the upper shield layer 20. The track width of read head of the head is 90 nm, while track width of recording head is 120 nm, and the number of turns of coil is 5 turns. Measurements have been conducted applying a coil current of 35 mA to a medium having the coercivity of 6.3 kOe.

For the measurements, the read outputs have been measured, as in the case of FIG. 2, by conducting recording and reading operations for 10,000 times in a certain recording frequency using the spin stand apparatus and the value obtained by dividing the difference between the maximum value and the minimum value of the read output with an average value thereof has been defined as an output changing rate. From FIG. 6, it becomes apparent that the read output does not change and is stabilized, unlike the results of measurements of FIG. 2(a) by introducing the three-layer structure in which the non-magnetic layer is held between the magnetic layers for the upper read shield in the side near to the main pole.

The upper shield layer 20 in the side nearer to the main pole in the upper read shield 21 is separated magnetically from the lower shield layer 18 with the non-magnetic layer 19 and therefore a material can be selected from wide range of materials and a material having the smaller linear expansion coefficient can be applied. In general, the materials called the invar or super-invar are also applicable and these materials are formed of FeNi or FeNiCo. In the case of the FeNi material, the composition of Ni is about 30 to 50 at %. In the case of the FeNiCo material, the composition of Ni is about 30 to 50 at % and the composition of Co is about 3 to 10 at %. The conventional materials such as permalloy (Ni₈₁Fe₁₉) and Fe₅₅Ni₄₅ can naturally be used. When these materials are used, the upper shield 21 can be formed continuously with the plating method using the resist frame plating method.

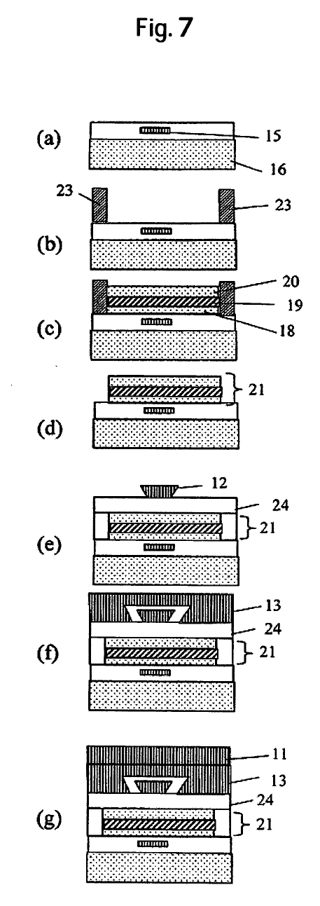

FIG. 7 shows schematic process diagrams illustrating an example of the method of forming the upper read shield 21. FIG. 7(a) shows formation of the lower read shield 16, the read element 15 composed of a magneto-resistive sensor such as GMR element or the like, and a gap thereof. FIG. 7(b) shows formation of the resist frame 23 after formation of the underlayer film for the plating although it is not illustrated. FIG. 7(c) shows formation by the plating method of the lower shield layer 18, non-magnetic layer 19, and upper shield layer 20 using the underlayer film for the plating and the resist frame 23. FIG. 7(d) shows formation of the upper read shield 21 by removing the resist frame, underlayer film for the plating and the unwanted portions. As the material of the lower shield layer 18, the permalloy or the like can be used. As the material of the non-magnetic layer 19, Cu, Au, Ru, Rh, Pd, Ta, NiP, NiPd or the like can be used. Moreover, as the material of the upper shield layer 20, FeNi or FeNiCo having the small linear expansion coefficient can be used in addition to the material of permalloy (Ni₈₁Fe₁₉) and Fe₅₅Ni₄₅.

It is of course possible to adopt the method in which the magnetic material for lower shield layer 18, non-magnetic material for non-magnetic layer 19 and the magnetic material for upper shield layer 20 are formed with the sputtering method to the entire part of the wafer without use of the plating method and thereafter a pattern is formed. In this case, for the non-magnetic layer 19, Al₂O₃, SiO₂, Ta₂O₅, TiO₂, Cr, Ta, and W can also be used in addition to Cu, Au, Ru, Rh, Pd, Ta, NiP, and NiPd or the like described above. FIG. 7(e) shows formation of the main pole 12 of the inverse trapezoidal shape after formation of the gap 24 for separating the read head and recording head. FIG. 7(f) shows formation of the trailing side shield 13 in the periphery of the main pole 12. FIG. 7(g) shows formation of the return pole 11. The material of this return pole will be described below.

Here, regarding film thickness of the magnetic film constituting the upper and lower shield layers 18, 20, it is desirable to form both magnetic film (lower shield layer) 18 near the read element and the magnetic film (upper shield layer) 20 near the main pole in the thickness of about 0.2 to 1 μm. The reason is that it is required to provide the magnetic characteristic as the magnetic shield, to reduce thickness of the layer not to deteriorate the thermal protrusion characteristic, and to consider the distance between the main pole and the read element. In addition, the desirable thickness is about 20 nm to 200 nm for the non-magnetic layer 19. It is desirable for the non-magnetic layer to have the thickness to decouple the upper shield 20 and lower shield layer 18 located in the upper and lower portions of the non-magnetic layer 19.

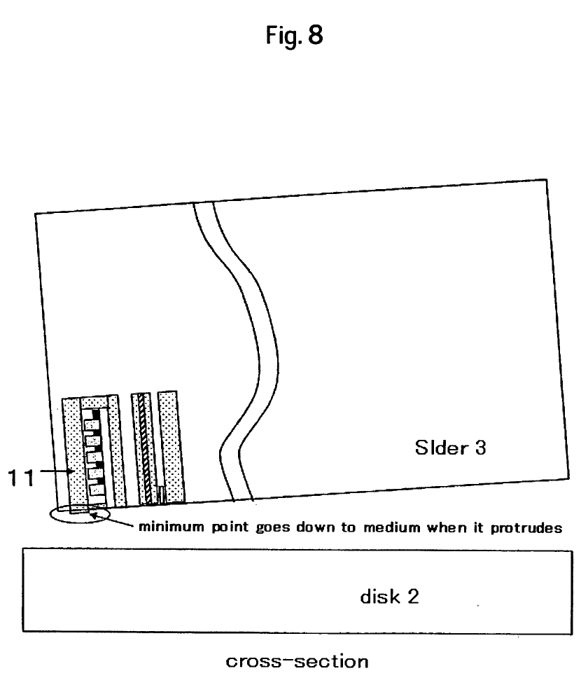

FIG. 8 illustrates the relationship between a slider (magnetic head) and a disk when it is floated. As illustrated in FIG. 8, since the return pole 11 is located in the trailing side, namely near the lowest point when the slider is located opposite to the disk in the case of the magnetic head for perpendicular recording having the constitution of the present invention, if the return pole 11 is protruded based on the thermal protrusion as the extrusion phenomenon of the element due to the temperature, a problem is generated in which the lowest point is further lowered, resulting in crash between the slider (magnetic head) and disk. Accordingly, it is desirable to use a material having small linear expansion coefficient for the return pole 11. For example, in general, the material called invar or super-invar may be used. This material is formed of FeNi or FeNiCo. In the case of FeNi material, the composition of Ni is about 30 to 50 at %. In the case of FeNiCo material, the composition of Ni is about 30 to 50 at % and the composition of Co is about 3 to 10 at %. The conventional material such as Fe₅₅Ni₄₅ can also be adapted because it has small linear expansion coefficient.

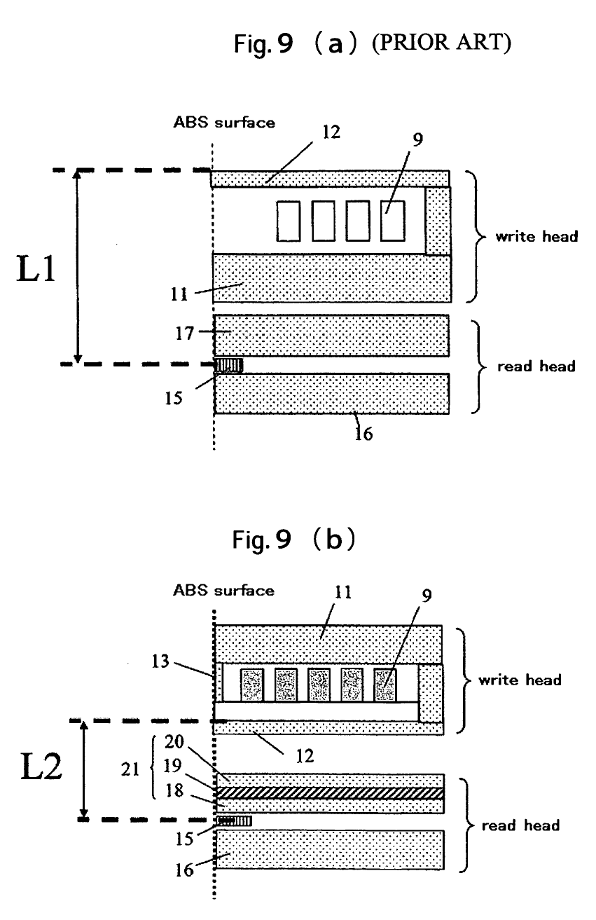

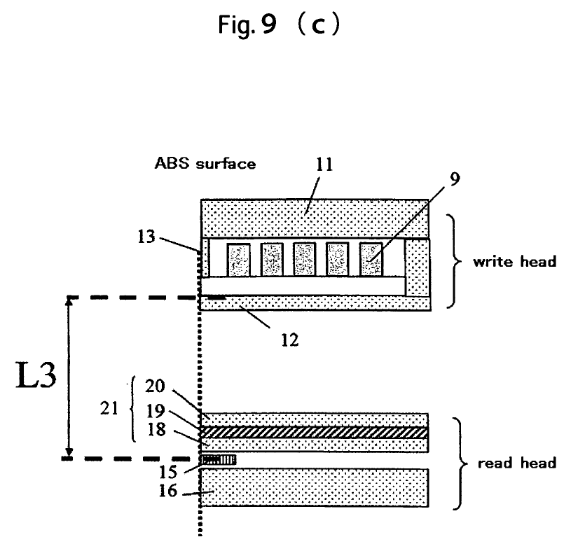

FIG. 9 comparatively illustrates cross-sections of the magnetic head for perpendicular recording of the type where the return pole is provided between the main pole and read head, namely of the conventional magnetic head for perpendicular recording and the magnetic head for perpendicular recording of the present invention. FIG. 9(a) shows the conventional magnetic head for perpendicular recording and FIG. 9(b) shows the magnetic head for perpendicular recording of the present invention.

The distance (L1, L2) between the read element 15 of read head and the main pole 12 is important for determining the format efficiency of the magnetic recording apparatus. As is apparent from the figure, L1 is clearly larger than L2 and the hard disk drive having more excellent format efficiency, namely the hard disk drive having larger storage capacity may be attained by utilizing the magnetic head for perpendicular recording of the present invention. In the case of the conventional magnetic head for perpendicular recording, L1 is typically 8 to 10 μm. Meanwhile, in the case of the magnetic head for perpendicular recording of the present invention, L2 becomes 1.02 μm when the film thickness of the lower shield layer 18 near the read element 15 is 0.2 μm, the film thickness of the non-magnetic layer 19 is 20 nm, the film thickness of the upper shield layer 20 near the main pole 12 is 0.2 μm, the interval between the upper shield layer 20 and main pole 12 is 0.2 μm, the film thickness of the yoke 14 is 0.2 μm, and the film thickness of the main pole 12 is 0.2 μm. As the typical value, L2 is 1 to 4 μm; however, since the format efficiency is 0.3% per distance of 1 μm between the read element and main pole, the format efficiency of 1.2 to 2.7% can be increased. On the other hand, FIG. 9(c) shows an example where the interval between the main pole and read head is increased. In this case, since the interval between the read element and main pole is as large as about L1 in FIG. 9(a), it cannot be said to be desirable from the viewpoint of the format efficiency but the effect for lowering influence of the magnetic field by the main pole on the read shield can thereby be attained.

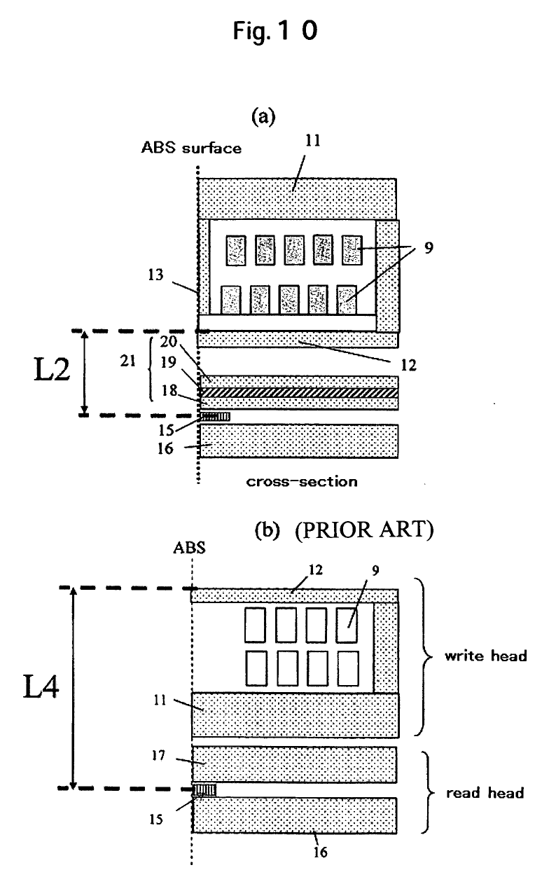

FIG. 10(a) comparatively illustrates the magnetic head for perpendicular recording of the present invention and the conventional magnetic head for perpendicular recording in which the coil is formed in two layers. FIG. 10(a) shows the magnetic head for perpendicular recording of the present invention, while FIG. 10(b), the conventional magnetic head for perpendicular recording.

In order to raise the writability of the recording head, it is required to increase a current value flowing into the coil or to increase the number of turns of the coil. However, when the size of coil is restricted, the current value is also restricted. Meanwhile, the number of turns of the coil can be increased but when importance is laid in the high-frequency characteristic, it is more desirable to make shorter the length from the air bearing surface of the main pole and return pole by forming the coil in two layers. In this case, as is apparent from FIG. 10(a), the magnetic head for perpendicular recording of the present invention is characterized in that the distance L2 between the read element 15 and main pole 12 is not changed from that in the case where the coil is formed in single layer. On the other hand, FIG. 10(b) shows an example of the conventional magnetic head for perpendicular recording in which the value of distance L4 between the read element 15 and main pole 12 when the coil is formed in two layers is larger than the value of L1 when the coil is formed in single layer. As described above, according to the present invention, the perpendicular recording type hard disk drive having excellent high-frequency characteristic and format efficiency can be provided by utilizing the magnetic head for perpendicular recording having employed the double-layer coil illustrated in FIG. 10(a).

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A magnetic head for perpendicular recording comprising:
a perpendicular recording head having a main pole and a return pole, and a read head having a first read shield, a second read shield, and a magneto-resistive sensor disposed between the first read shield and second read shield,
wherein the main pole is formed between the return pole and the first read shield, and
wherein the first read shield comprises an upper shield layer in the side of the main pole, a lower shield layer in the side of the magneto-resistive sensor, and a non-magnetic layer formed between the upper shield layer and the lower shield layer.

2. The magnetic head for perpendicular recording according to claim 1, further comprising a trailing shield or a trailing side shield on a trailing side of the main pole.

3. The magnetic head for perpendicular recording according to claim 2, wherein the trailing shield or trailing side shield is magnetically coupled with the return pole.

4. The magnetic head for perpendicular recording according to claim 1, further comprising coils between the main pole and the return pole.

5. The magnetic head for perpendicular recording according to claim 4, wherein the coils are provided in two or more layers between the main pole and the return pole.

6. The magnetic head for perpendicular recording according to claim 1, wherein the upper shield layer is formed of FeNi whose Ni composition is about 30 to 50 at % or FeNiCo whose Ni composition is 30 to 50 at % and composition of Co is about 3 to 10 at %.

7. The magnetic head for perpendicular recording according to claim 1, wherein the return pole is formed of FeNi in which composition of Ni is about 30 to 50% or FeNiCo in which composition of Ni is about 30 to 50% and composition of Co is about 3 to 10%.

8. The magnetic head for perpendicular recording according to claim 1, wherein the non-magnetic layer is formed of Cu, Au, Ru, Rh, Pd, Ta, NiP, NiPd, Al₂O₃, SiO₂, Ta₂O₅, TiO₂, Cr, Ta or W.

9. A method of forming a magnetic head for perpendicular recording, the method comprising:
forming a perpendicular recording head having a main pole and a return pole; and
forming a read head having a first read shield, a second read shield, and a magneto-resistive sensor disposed between the first read shield and the second read shield, wherein the main pole is formed between the return pole and the first read shield,
wherein the first read shield includes an upper shield layer in the side of the main pole, a lower shield layer in the side of the magneto-resistive sensor, and a non-magnetic layer formed between the upper shield layer and the lower shield layer, and
wherein the upper shield layer, lower shield layer, and non-magnetic layer are formed by a plating process.

10. The method of forming a magnetic head for perpendicular recording according to claim 9, further comprising forming a trailing shield or a trailing side shield on a trailing side of the main pole.

11. The method of forming a magnetic head for perpendicular recording according to claim 10, wherein the trailing shield or trailing side shield is magnetically coupled with the return pole.

12. The method of forming a magnetic head for perpendicular recording according to claim 9, further comprising forming coils between the main pole and the return pole.

13. The method of forming a magnetic head for perpendicular recording according to claim 12, wherein the coils are provided in two or more layers between the main pole and the return pole.

14. The method of forming a magnetic head for perpendicular recording according to claim 9, wherein the upper shield layer is formed of FeNi whose Ni composition is about 30 to 50 at % or FeNiCo whose Ni composition is 30 to 50 at % and composition of Co is about 3 to 10 at %.

15. The method of forming a magnetic head for perpendicular recording according to claim 9, wherein the return pole is formed of FeNi in which composition of Ni is about 30 to 50% or FeNiCo in which composition of Ni is about 30 to 50% and composition of Co is about 3 to 10%.

16. The method of forming a magnetic head for perpendicular recording according to claim 9, wherein the non-magnetic layer is formed of Cu, Au, Ru, Rh, Pd, Ta, NiP, NiPd, Al₂O₃, SiO₂, Ta₂O₅, TiO₂, Cr, Ta or W.
